(19) United States
(12) Patent Application Publication
(10) Pub. No.: US 2004/0138925 A1
(43) Pub. Date: Jul. 15, 2004

(54) Resources utilization management system and method of use

(76) Inventor: Shu Sean Zheng, Houston, TX (US)

Correspondence Address: TIM L. BURGESS, P.C., 402 OAK LANE, HOUSTON, TX, 77024, US

(21) Appl. No.: 10/744,029

(22) Filed: Dec. 23, 2003

Related U.S. Application Data
(60) Provisional application No. 60/436,245, filed on Dec. 23, 2002.

(51) Int. Cl. G06F 17/60

(52) U.S. Cl. 705/2

(57) ABSTRACT

A computerized resources utilization management system, comprising a visuals display device for displaying computer generated visuals expressing the status in real time of at least some of a plurality of objects in a predetermined arrangement within a pattern of a plurality of such arrangements, one such object comprising a subject occupying space and the other objects comprising at a plurality of one or more resources or one or more properties of one or more resources, or both, at least one of the one or more resources being an extent of space at least sufficient for occupancy of the subject, and at least one other of the one or more resources or the one or more properties of resources, or both, being selectively available for assignment to the subject by one or more users, and a computer system operably communicative with the visuals display for communicating inputs to the display, the system including at least one input facility for taking such inputs, such inputs including at least identification of the subject and inputs assigning resources and properties of resources t to the subject.

### CROSS REFERENCE TO RELATED APPLICATIONS

This application claims the benefit of 35 U.S.C. 111 (b) Provisional Patent Application Ser. No. 60/436,245, filed Dec. 23, 2002, and entitled, “Workforce communication and Workflow Management System.”

### BACKGROUND OF THE INVENTION

Separately, clinics and hospitals in the US have been experiencing severe problems in capacity utilization and operational efficiency. Patients, physicians, nurses, medical assistants and technicians wait on each other dozens, and even hundreds, times a day. Patients wait because medical staff may not be prioritizing patient examination according to the time the patient has been waiting. Physicians, nurses, medical assistants and technicians wait on each other because they can not effectively quickly and easily communicate with each other on a real time basis about completion of their respective work responsibilities for a patient; lacking a real time advisory of status of work flow on a patient, they cannot time-effectively allocate the interactional skill and equipment utilization resources for which they have respective responsibilities to alleviate both their wait and in turn the patient's wait. While there exist some systems that use switches in examination or hospital rooms to switch on lights mounted outside examination rooms to show the room is not empty or that a patient is being treated in the room, these do not give a real time status of the patient wait or advise a physician, nurse, medical assistant or technician that one of them is needed now nor do they advise the one needed what they are needed for if one or more doctor ordered procedures are to be performed on the patient by one or more responsible nurses, medical assistants or technicians. Existing other solutions, such as pagers, loud speakers, telephones, message boards, plastic flags, or computer-based emails or instant messaging, all lack the ability to deliver real time communication among a work group of dispersed members who are spatially separated. These systems also do not store data to factually and accurately allow analysis of individual productivity and efficiency of operations. Further, they do not integrate with electronic medical record systems.

The root cause of this operational problem is the simple fact that clinics and hospitals do not have a convenient way to record, display, analyze, or simply to manage their operational data.

Separately, a problem in patient management is the Health Insurance Portability and Accountability Act of 1996. It requires healthcare entities to protect patient identity and privacy in their daily operations. Physician clinics and hospitals have trouble observing this HIPAA requirement throughout the day. They ask patients sign their names, address, and phone number on a sign-in sheet, which is left unprotected on the check-in counter. Even if they manage to avoid this, they may publicly call patients by their names in the waiting room or on loud speakers. They often write patients' name on the outside of the exam room doors.

### SUMMARY OF THE INVENTION

This invention provides instant communication across teams of people who work in a fast-paced environment, such as a medical clinic or hospital. They use this invention to show status of their work and to communicate with each other when requesting others' help. Clear visual effect and ease of use are key to this system. The essence of this invention is a system and method for computerized management of resources, manifested in tasks and status. This system and methodology enables a new set of business processes to improve the resources' capability and efficiency. This system also interfaces with other healthcare information technology (“IT”) systems, such as practice management (“PM”) and electronic medical records (“EMR”). In fact, this system can serve as a platform to replace all or part of the user interfaces of these PM and EMR systems. In addition to this System's inherent merit of improving operational efficiency, it derives value from this ability to “glue” together the numerous incompatible PM and EMR systems on the market today. The architecture of the system is not limited to provision of medical services but has general application to uses of subject matter, resources applicable to the subject matter, and properties of resources.

In accordance with this invention, there is provided a computerized resources utilization management system. The system comprises a visuals display device for displaying computer generated visuals expressing the status in real time of at least some of a plurality of objects in a predetermined arrangement within a pattern of a plurality of such arrangements. One such object comprises a subject occupying space. Other objects comprises at a plurality of one or more resources or one or more properties of one or more resources, or both. At least one of the one or more resources is an extent of space at least sufficient for occupancy of the subject. At least one other of the one or more resources or the one or more properties of resources, or both, is selectively available for assignment to the subject by one or more users.

The system further comprises a computer system operably communicative with the visuals display for operating the display and for communicating inputs to the display. The system includes at least one input facility for taking such inputs. Such inputs include at least identification of the subject and inputs assigning resources and properties of resources t to the subject.

In an embodiment, the management system arrangement is a row and the pattern is vertically stacked rows forming columns of cells in a grid of rows and columns. In an embodiment, each row includes a cell in one column representative of the extent of space resource.

In an embodiment, one or more cells in the row include one or more elapsed time indicators representing time progression of status changes.

In an embodiment in which the management system is useful in the medical community, the subject is a patient, the extent of space resource is a bed or a room, and others of the resource objects include human resources, at least one of which is a health care provider. The human resources include a physician, a medical assistant and a non-medical assistant, properties of the medical assistant resource include medical treatments assignable by such physician, and properties of the non-medical technician include non-medical tasks assignable by the physician. In this embodiment, the system is space resource centric with all services (properties of the resource) being supplied in an identified space resource, such space resource being, for example, a bed or table in a hospital ward room or a hospital emergency room which may be shared by other occupants, in a broader sense, the room itself in a hospital such as an unshared ward room or emergency room or a hospital surgical room, or an examination or surgical room in a clinic or doctor's office. The input of an identification of the subject is an identification of the patient and is placed in a cell of a row which includes a cell for an extent of space resource and cells for resources or properties of resources, or both, for the identified patient. In a particular embodiment one cell serves two purposes, and the cell in which the patient identification is placed also represents extent of space resource.

In another embodiment useful in the medical community, especially where therapy, for example, physical or occupational therapy, is being accorded a patient, the management system is resource properties centric and the patient is moved to each space resource such as a therapy station where the particular therapy is applied. In this embodiment, the subject is a patient, the input of an identification of the subject is an identification of the patient, the patient identifications are input for inclusion in one or more rows containing cells representative of a wait area for patients, and the cells in at least one or more other rows in the grid are each representative of a resource or properties of a resource to which a patient can be moved. This space resource is at least sufficient for occupancy of the patient and for other resources or properties of resources for use by or ministration of services to the patient at such space resource. Each such row represents a differently designated resource or property of a resource.

In this embodiment, the other properties of resources may comprise specified treatment locations.

As this or in in the first mentioned medical community embodiment, there may be one or more cells in the row including the patient identification cell which include one or more elapsed time indicators representing time progression of status changes.

In an embodiment, the visual display is located in an area near the space resources represented by cells in the column representative of space resources.

In an embodiment, the input facility is a touch sensitive display separate from the visuals display. The touch sensitive display is one that senses contact by a user in regions of the touch sensitive display. The regions correspond to cells in the visual display.

The management system can be carried out by one computer that communicates with the visual display (as for example, might be implemented in a sole practitioner doctor's office having more than one patient examination room) or can be carried out in a system in which a computer communicates across a network of computers. In either instance, at least one computer has a resources management database for recording creation of a subject record and events of input to the display. One or more of the inputs of the input facility signify billable medical services. In an embodiment, a computer either alone or in a network has communication with practice management and electronic medical records databases, and the inputs of the input facility which signify billable medial services are recorded in the appropriate one or both of the practice management and electronic medical records databases.

This invention also includes, as mentioned, methodology for managing utilization of resources. An embodiment of the methodology is a method applicable to a space resource centric model. In this method, a management system is provided comprising a visuals display device for displaying computer generated visuals expressing the status in real time of at least some of a plurality of objects in a predetermined arrangement within a pattern of a plurality of such arrangements, one such object comprising a subject occupying space and the other objects comprising at least one defined resource or defined properties of at least one resource, or both, at least one of the one or more defined resources or the one or more defined properties of resources, or both, being selectively available for assignment to the subject by one or more users, at least one of the resources being an extent of space at least sufficient for occupancy of the subject. The management system further includes a computer system operably communicative with the visuals display for communicating inputs to the display, the system including at least one input facility for taking such inputs. The method uses the management system. The input facility is used to input an identification to a subject and an assignment of an extent of space resource to the identified subject, thereby causing the visuals display to display a representation of the identified subject in the assigned extent of space. The identified subject is placed in the assigned extent of space. The input facility is used to input a selection of at least one property of at least one resource for application to the identified subject, thereby causing the visuals display to display a representation of each such resource property or properties selected for application to the identified subject. A selected property of a selected resource is applied to the identified subject. The input facility is used to input a completion of application of a resource property selected for application to the subject identification, thereby causing the visuals display to display a representation of completion of application of such resource property selected for application to the subject identification. This is repeated until all selected properties of all selected resources have been applied. The identified subject is then removed from the assigned extent of space, and the input facility is used to input a lack of occupancy of the assigned extent of space, thereby causing the visuals display to display a representation of lack of occupancy of the assigned extent of space.

This method for a space resource centric model may be one in which the computer system comprises a network of computers, at least one computer of which has a resources management database for recording creation of a subject record and events of input to the display. In such case, the method includes recording inputs of change of status onto the display.

Another embodiment of the methodology of this invention is a method applicable to a resource properties centric model. In this method, a management system is provided which comprises the management system described in the preceding paragraph, inclusive of the visuals display device and the computer system with its input facility, in this case, the inputs including at least identification of the subject and inputs assigning resources and properties of resources to the subject. The input facility is used to input an identification to a subject, thereby causing display of the subject identification on the visuals display. The input facility is used to input a selection of at least one resource not a space resource and at least one property of such selected resource for application to the identified subject, each property being located in an extent of space resource in the pattern, thereby causing display on the visuals display of a representation of the subject in a representation of the extent of space where the selected property for application to the subject is located in the pattern. The identified subject is placed in an extent of space resource where the selected property is located for application to the subject. The selected property of a selected resource is applied to the subject. The input facility is then used to input a completion of application of the selected property to the subject, thereby changing the displayed status of the representation of the subject in the representation of the extent of space to indicate completion of application of the selected property to the subject. The application of a selected property to the subject and the input of completion of the application is repeated until all selected properties have been applied.

The invention will be further described in connection with specific embodiments both by the drawings and by a further detailed description of the invention and embodiments of the invention.

### DESCRIPTION OF THE DRAWINGS

FIG. 1 is a schematic of a computer system comprising a network including the visual displays and input facilities of the resources utilization management system of this invention.

FIG. 2 is a depiction of a visuals display of the resources utilization management system of this invention in which a vertical status arrangement is employed.

FIG. 3 depicts a plurality of vertical status visuals display mounted back-to-back in a hall passageway.

FIG. 4 depicts observation of vertical status displays mounted in a hall passageway by a health care provider.

FIG. 5 depicts an exam room visuals display.

FIG. 6 depicts a pop up task assignment window accessed from a staff visuals display.

FIG. 7 depicts a health care provider using an exam room touch screen visuals display.

FIG. 8 depicts a staff visuals display having a timer set.

FIG. 9 displays a multi-pod common area display.

FIG. 10 depicts a patient check in and check out module window.

FIG. 11 depicts a patient check in and check out module window with entries.

FIG. 12 depicts a patient waiting room multi media module.

FIG. 13 depicts a first part of a visuals display of the resources utilization management system of this invention in which a horizontal status arrangement is employed.

FIG. 14 depicts an assign resource window module for management of the visual display of FIG. 13.

FIG. 15 depicts a second part of visuals display of the resources utilization management system of this invention in which a horizontal status arrangement is employed.

FIG. 16 depicts an assign task window module for management of the visual display of FIG. 15.

FIG. 17 depicts part one of a flow chart of events in usage of the vertical status visuals display of the arrangement of the resources utilization management system of this invention.

FIG. 18 depicts part two of a flow chart of events in usage of the vertical status visuals display of the arrangement of the resources utilization management system of this invention.

### DETAILED DESCRIPTION OF THE INVENTION

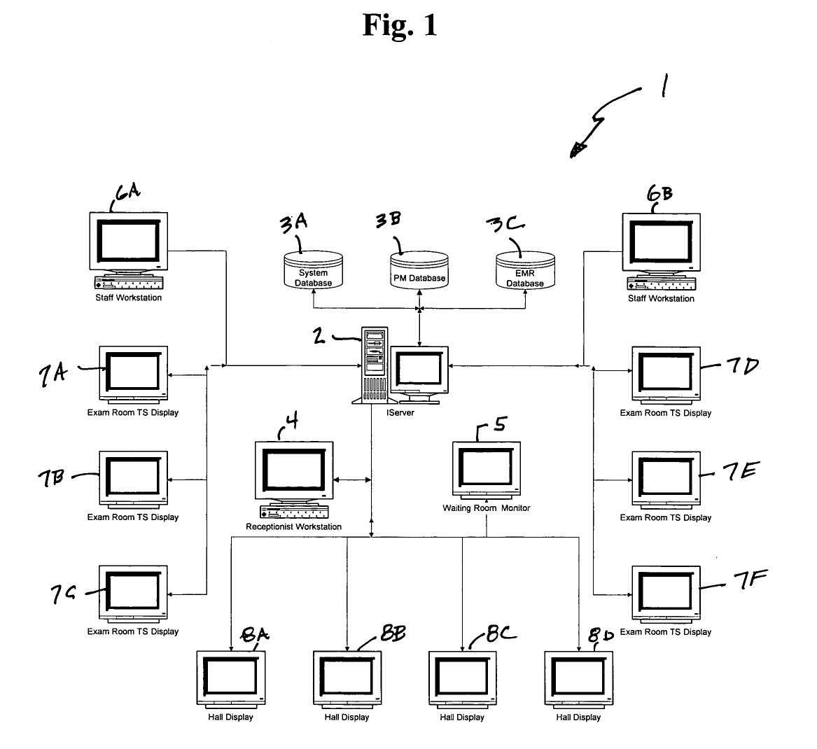

The invention comprises a computerized resources management system an exemplary embodiment of which is depicted by reference numeral 1 in FIG. 1. Referring to FIG. 1, a computer system suitably inclusive of a network server 2 (although one is shown in the schematic of FIG. 1, server 2 conceptually may represent a plurality of servers) has access to a system database 3A, a PM database 3B, and EMR database 3C. Included in said computer system in communication with said server 2 is a receptionists or admissions clerk workstation 4 in a patient admissions area, a waiting room monitor 5, a plurality of staff work stations 6A and 6B in health provider offices, a plurality of examination room display monitors 7A, 7B, 7C, 7D, 7E and 7F each in separate examination rooms, and a plurality of hall display monitors 8A, 8B, 8C and 8D in halls near the examination rooms. As explained below, an embodiment of the invention makes use of touch screen display monitors. The abbreviation “TS” in the legend for the examination room display monitors 7A, 7B, 7C, 7D, 7E and 7F means “touch screen.” The computer system 1 is operatively communicative with the hallway visuals display monitors 8A, 8B, 8C and 8D for running and communicating inputs to all such display monitors. A dedicated computer may be used to run the hallway display monitors, or one may use a built-in capability of an operating system for supporting multiple external monitors and designate the hallway display to occupy a second and/or third monitor status. These external monitors may be mounted on the ceiling or the walls. One mounting method is to use VESA compliant monitors and mounting brackets. Alternatively, video expansion PCI cards and long video cables may be used to connect and feed these monitors from one centrally located computer.

The term “display” as used in connection with the phrase “visuals displays” either explicitly or implicitly as context shows refers essentially to the display exhibited by a monitor, although when speaking of displays sometimes the sense of the sentence will indicate that the word incorporates the monitor making the display. The visuals displays on the monitors of 7A, 7B, 7C, 7D, 7E and 7F of the examination rooms and hall monitors 8A, 8B, 8C and 8D display visuals generated by the computer system that express the status, in real time, of at least some of a plurality of objects in a predetermined arrangement within a pattern of a plurality of such arrangements. By the term object is meant structure which is subject matter, resource or property of a resource.

An embodiment of the invention described hereinafter applies to a medical clinic, as a non-limiting illustration. This embodiment is space resource centric. A clinic is staffed by providers which may include, for example, physicians, physicians in specialty training (e.g., residents), medical assistants, which may be nurses or licensed vocational nurses or the like, non-medical assistants, such as x-ray technicians, splinting or casting or other technicians, translators, financial consultants, occupational therapists, and operating staff such as receptionists. The providers interface with a patient in a reception area, a private examination room, a testing area (for example where cardiac stress testing is performed) or another place in the clinic. In the context of subject matter, resource and property of resource objects, the patient is the subject matter object on which the process of the invention acts. In the invention, one object comprises a subject occupying space and the other objects comprising at least one defined resource or defined properties of at least one resource, or both. Resource objects are resources such as an extent of space (a place, such as an examination room), providers, and equipment. Properties of resources include tasks performed by providers or equipment. A product of the objects may also be an object, such as a record of services provided, put into a database.

In the invention, one or more defined resources or one or more defined properties of resources, or both, are selectively available for assignment to the subject by one or more users, at least one of the resources being an extent of space at least sufficient for occupancy of the subject.

The visuals displays provide the essential interface of the invention. The design principle is to use visual representations, such as colors, letters, numbers, shapes, icons, lines, borders, sounds, and animation, such as flashing, cycling, and movements, to present meaning to the readers. The designer of the display arrangement constructs the arrangement of the objects on the display to bet suit the particular best utilization of resources sought to be managed through use of the display. The observing users of the display can communicate to each other significant amounts of information in real time that are understood in one glance.

Reference is made to FIG. 2, in which reference numeral 10 generally designated an example of a visual display made in accordance with the invention. Visual display 10 is a vertical status display design in which resources are listed in vertical columns while subjects are listed in horizontal rows. The rectangular areas on this display that are formed by the intersection of a row and a column is called a cell. Each cell can display background colors that represent different meaning. The designer in collaboration with the users of the system can specify the meaning of these colors.

In the display of FIG. 2, a limiting principle in the organization is readability of the letters and numbers from a distance. A rule of thumb limitation is that an observer of average sight perception has difficulty identifying a letter or number smaller than one inch tall from a distance of 50 feet. This perception ability is substantially proportional as distance decreases, so at 25 feet, the letter or number should be at least one-half inch tall. This readability limitation means that each cell can only display a few characters or numbers to show abbreviated messages. The number of characters shown in each cell is dependent on the height of the cell and the font chosen. It is desirable to maximize letter height and to use a font that is proportionally wide enough to be read comfortably at a distance, for example, a san serif font.

Each cell can show multiple messages and or colors at one time. The most convenient way to show them is to cycle them at predetermined intervals, for example, on half-second intervals (“at one time” is relative in this case). The interval is customizable by the designer in collaboration with the user. Another solution is to combine the few abbreviations in to one cell, for users who know how to read them.

Each cell can also be split into sub-cells, either horizontally or vertically, in order to show more information. An exemplification of this is described in connection with a horizontal status display after the description of an example of a vertical status display.

Visual aids may be employed in a display of the system of this invention to help with readability, which can also be designed in collaboration with the specific users. For example, a thin line, with a contrasting color to the overall background, may be inserted between the third and the fourth rows on the six-row vertical display of FIG. 2, or between the second and third and between the fourth and fifth row. Alternatively, or in addition, rounded rectangular outlines of each cell can also be used to both aid visibility and present more meaning.

The display, in either the vertical status format of FIG. 2 or the horizontal status display described below, is dynamically reconfigurable. In other words, the user can change the number of rows or columns in real time, and the display will recalculate the proper size of each cell and the letter height, and display them accordingly.

The total display area on the display limits the number of alphanumeric objects that can be placed in the display and still maintain readability according to the one inch at 50 feet ratio. The display in FIG. 2 is organized for a 17 inch flat panel display, and in this embodiment, which is adapted for a medical clinic, permitted four columns and six rows. The subject listing in horizontal rows is a patient. The principals of convenient readability from a distance limit the number of examination room resources that can be displayed to six in the context of a total of three other fundamental resources. First column 12 is an examination room resource, second column 14 is a medical assistant (here, a nurse) resource, third column 16 is a non-nurse resource, and fourth column 18 is a physician resource. Since six examination rooms are to be displayed, six rows by four columns or 24 cells are dictated. In this context of a specified number of rows, the patient subject matter is suitably placed in the same cell as an examination room. Thus the horizontal rows represent patients. Accordingly, in display 10, first row 20 of first column 12 is a cell 21 representing examination room #1, second row 22 of first column 12 is a cell 23 representing examination room #2, third row 24 of first column 12 is a cell 25 representing examination room #3, fourth row 26 of first column 12 is cell 27 representing examination room #4, fifth row 28 of first column 12 is a cell 29 representing examination room #5, and sixth row 30 of first column 12 is a cell 31 representing examination room #6. The cells may be represented by x for horizontal and y for vertical nomenclature, with subscripts for the letter indicating the row (e.g. x₁=row 1) and column (y₁=column 1) so x₁y₁ means examination room #1 in cell 21.

Since the rows represent subject matter (patients), each examination room either is available for housing a patient or is already housing a patient. The representations of the examination rooms of cell 21 (x₁y₁) (examination room #1), cell 23 (x₂Y₁) (examination room #2), cell 25 (x₃y₁) (examination room #3), cell 27 (x₄y₁) (examination room #4), cell 29 (x₅y₁) (examination room #6) and cell 31 (x₆y₁) (examination room #6) in FIG. 2 use color to indicate the overall status of the examination rooms. For example green means room “empty” (and in an embodiment, may, if containing a patient number, means the patient has been assigned to the room and may be in the room but has not yet seen by a provider or is in the process of being seen by a provider who may be one who attends to the patient before the patient is seen by a doctor, for example, a nurse who takes temperature, weight, pulse etc.), red means “patient in room and waiting for treatment” or “doctor needed,” yellow means “patient in room and undergoing treatment,” and blue means “treatment on patient is completed, patient checking out, and room in cleanup status.”

The representations also use alphanumeric terminology in the colored cells 21, 23, 25, 27, 29 and 31 to represent an identification and characteristic of the patient. For example, a number is a patient number and letters represent a characteristic of the patient, such as E=established patient, N=new patient, P=post-operative patient, S=second opinion patient, R=RME/IME (these are nerve tests) patient, C=case manager, I=impairment rating patient, U=unknown. Dashes in a cell indicate the examination has no patient assigned to the room.

Thus in FIG. 2, the alphanumeric “5S” in cell 21 (x₁y₁) (examination room #1) means the patient is identification number 5 having the characteristic “second opinion.” The reader of the display of course simply recognizes from instruction that the first cell in column one is examination room #1. The background of examination room #1 is, say yellow, so this indicates patient 5S is in room #1 undergoing treatment. Similarly, patient 6E (patient 6, characteristic “established patient”) shown in examination room #2, that is, cell 23 (x₂y₁), has a color, say blue, as the background for examination room #2, which indicates that treatment is concluded, the patient is checking out and that the room is ready for clean up or is in the course of cleanup. Cell 25 (x₃y₁) has patient 7P, a post operational patient, in examination room #3, with a background color of, say red, indicating that the patient is ready for treatment (doctor needed). Cell 27 (x₄y₁) has a patient 9N (new patient) in examination room #4, having a, say green, background, indicating that the patient is assigned to room #4 and either is awaiting a nurse or a nurse is attending to the patient. Examination room #5 (cell 29 (x₅y₁)) has no patient number assigned to it and is empty and ready for occupancy, as indicated by a background color of green in the absence of a patient number. Examination room #6 (cell 31 (x₆y₁)) has a background color of yellow, indicating new patient 8N is undergoing treatment.

The medical clinic for which FIG. 2 is an embodiment of a display is presented as one specializing in hand surgery and the resources in second column 14 and third column 16 are presented as tailored to the resource choices of the physicians of the clinic. Second column 14 (FIG. 2) is a representation of a medical assistant resource (here, typically a nurse or other aid resource needed by a nurse or a doctor). Dashes mean no task for the medical assistant to perform. Any one or more of multiple cycling abbreviations indicate nurse tasks to be performed. For example, these may be INJ for injection, DSG for dressing, PIN for pin removal, PRE for prescription, REP for a report form which the patient or doctor needs a medical assistant to complete(such as time-off-letter or test results) SUR for schedule for surgery, SUR for suture removal, TEL for bring a portable telephone, TST means either nurse do some simple test or to setup tests for the doctor, as in getting the test equipment ready) TRA for translator needed, etc. Thus cell x₁y₂ in which the letters TRA appear indicate that in examination room #1 where patient 5S is undergoing treatment ((cell x₁y₁) is yellow), a translator is needed.

Third column 16 (FIG. 2) is a technician or other resource than included in third column 14. Dashes mean no task for the technician or other resource than included in third column 14 to perform, any one or multiple cycling abbreviations indicate the tasks to be performed. For example, X-R for x-ray, S-C for splint cast, R-F for resident fellow (summoning a resident fellow for observation of or participation in a procedure), FIN for financial counseling, OT for occupational therapist, etc. Thus examination room #3 has had a test performed (cell x₂y₂) but not cleared from the room from which established patient 6E is checking out. Examination room 6 in which new patient 8N is receiving treatment (background color yellow for cell x₆y₁) has a nurse summoned or present for pin removal.

Fourth column 18 (FIG. 2) is the physician resource. Color and/or abbreviations indicate the designated physician. This in red can mean physician #1, blue physician #2, green physician #3, yellow physician #4, orange physician #5, brown physician #6, etc. A color of a cell in fourth column 18 in a particular row indicates that the doctor is the assigned doctor for the patient in that row. Thus yellow in column 4, row 1 (cell x₁y₄) means physician #4 is the physician for patient 5S in examination room #1, red in column 4, row 2 (cell x₂y₁) means physician #1 is the physician for patient 6E in examination room #2, green in column 4, row 3 (cell x₃y₄) means physician #3 is the physician for patient 7P in examination room #3, blue in column 4, row 4 (cell x₄y₄) means physician #2 is the physician for patient 9N in examination room #1, and red in column 4, row 6 (cell x₆y₄) means physician #1 is the physician for patient 8N in examination room #6. Thus the display informs that physician #1 has completed seeing patient 6E who is checking out and is now treating patient 8N in examination room #6. Since only color is shown in fourth column 18, space for an alphanumeric representation is not needed, so column 18 is narrowed to allow more room for cells size in columns 12, 14 and 16 and hence more room for alphanumeric representations in those columns.

The display of FIG. 2 is suitably located in an area near a group of space resources for which the display can exhibit a representation, in the embodiment of FIG. 2, near six examination rooms. A group of examination rooms herein is called a pod. Ordinarily examination rooms are accessed by a common passageway and if linearly arranged in a sequence along the passageway, end to end, or on opposing sides of the passageway, the passageway normally is a hall. For convenience, but without limitation, this display herein is called a hall or hallway display but only to signify that it is a common area display which is not in the examination room or in staff offices. Ordinarily the hallway display will be a read only display to lock out unauthorized inputs. Using the graphics manager for the computer operating system employed, the pattern representing the grid of resources is maximized to fill the entire area or window of the monitor which exhibits the display. When possible, the window is shown without its borders, so that the display has clean graphics from edge to edge. Suitably in some facility layouts, hallway display monitors may be mounted back to back, so they may be read from up or down a hallway.

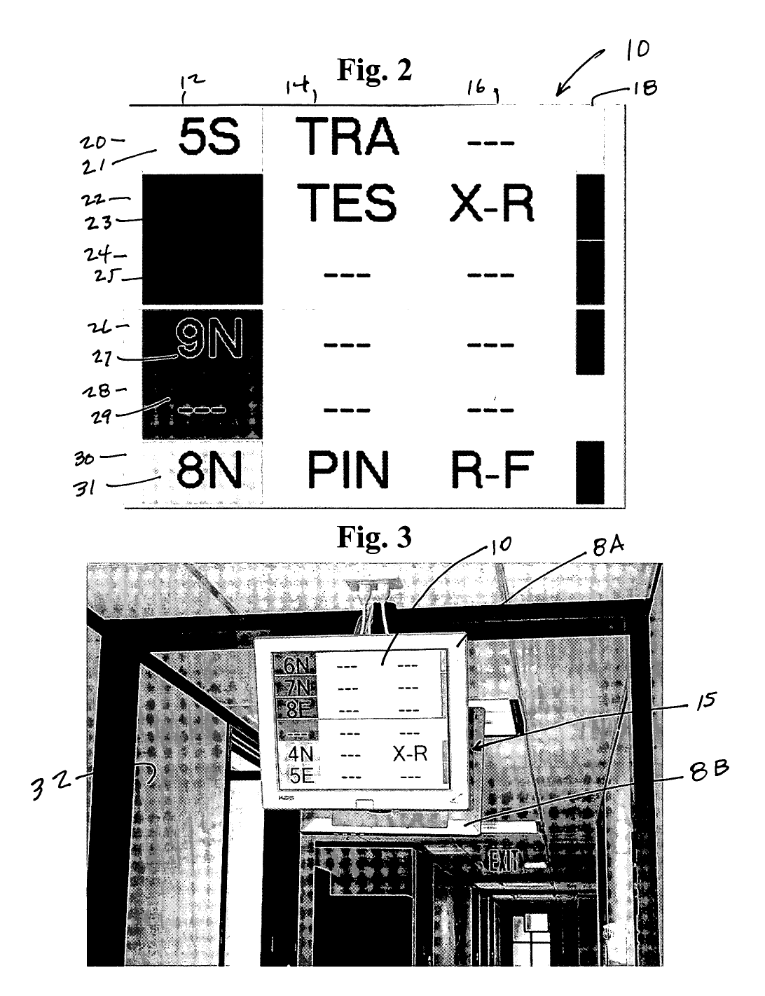

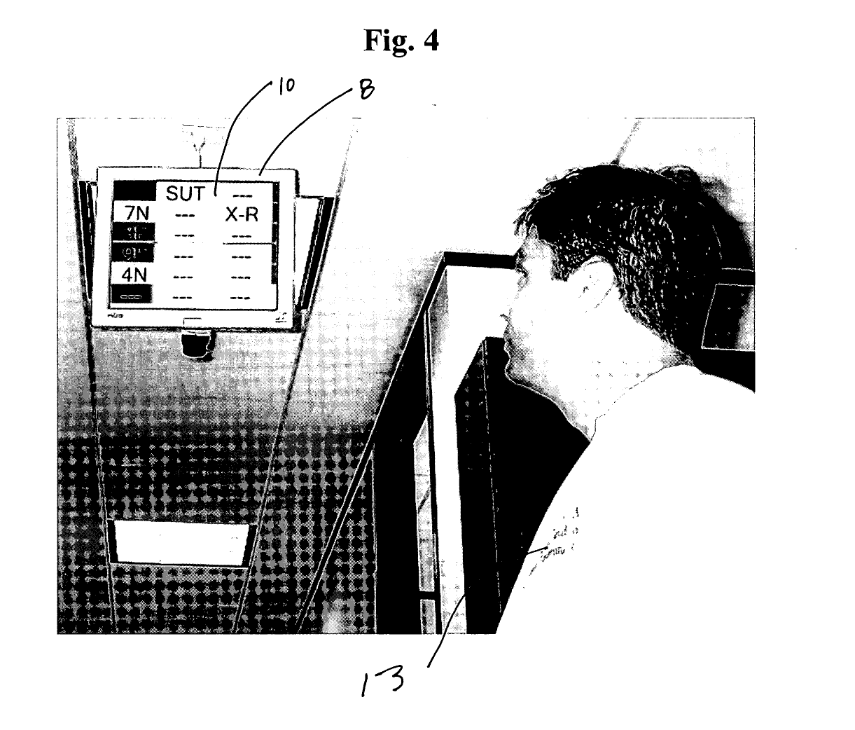

Referring to FIG. 3, an example of a monitor 8 for a display 10 of this invention as mounted in a hallway 32 is depicted. The monitor 8A for display 10 is mounted back to back with another identical display monitor 8B, as indicated by reference numeral 15. Referring to FIG. 4, there is shown the representation of a user physician 13 (for example, resource #5 having the fourth column display color orange for identification), reading display 10 on a hallway monitor 8. Display 10 signifies, by the physician's color in cell positions (x₁y₄), (x₂y₄) (x₃y₄), (x₄y₄), (x₅y₄) in the first through fifth rows 20, 22, 23, 24, and 25 of fourth column 18, that he is needed in examination rooms 1-5.

The staff and the physicians of a particular pod require a way to input into the hallway display their work status and issue or respond to task requests. Optionally the physicians in collaboration with the designer may want to limit an individual's ability to issue or respond to tasks. For example, they may only allow the physician to issue requests, or that requests can only be made from inside the examination rooms. In the embodiment herein described for a vertical status display, a staff display is made for the latter scenario. A staff display is the same as the hallway display, except the cells that represent the physician resources are clickable buttons; in the case of vertical status display 10 they are the cells in the second and third columns 14 and 16. The simplest action of these buttons is a toggle switch to first acknowledge the task then to indicate the completion of the task. Upon acknowledgement, the background of the particular cell can change color to indicate that the task is being performed. Upon completion, the message in the cell can simply disappear, or optionally change to another color, for example, to remind the physician about the requested task and to indicate that the task is completed. Information about the acknowledgement and the completion inputs by the staff suitably are recorded in the system's database, such as time-stamp, staff identity, and reference to the medical details of the task.

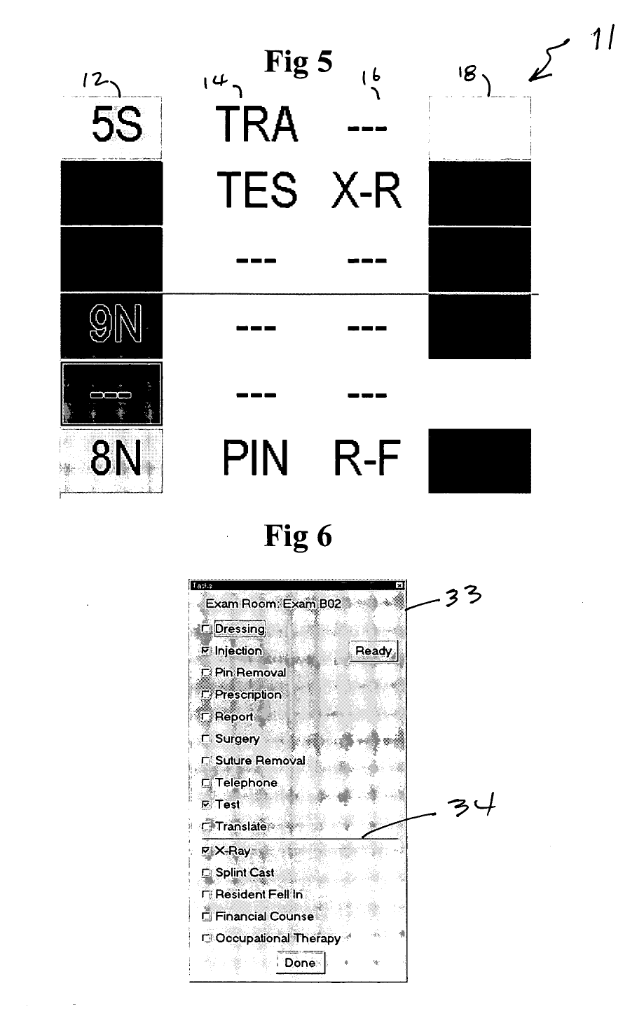

FIG. 5 depicts a display 11 of a staff workstation 6 or on an exam room monitor 7. Display 11 has the same row and column layout as hall display 10. The fourth column 18 is widened to be the same size of the first column 12. The cells of the first and the fourth columns 12 and 18 are buttons, similar to the cells of the second and third columns. This display 11 is used in each exam room to control the status of the exam room and to issue task requests. Each time the physician clicks in a cell in the first column 12, the background color changes to the next color in the sequence that is preset by the clinic. Information about this change is recorded in the system's database 3A. If the clinic does not prescribe a set sequence of room status changes, then when a cell in the first column is clicked, a menu pops up showing the available choices. These choices are shown by large colored and/or abbreviated messages. After the physician clicks on one choice, the menu disappears and the choice is shown in the exam room display. In the embodiment depicted, the clinic has prescribed a color sequence so that the normal routine of client handling is enforced.

Referring to FIG. 5, with the staff display 11, when the physician wants to issue a task to a nurse or technician, the physician clicks the physician's cell in the fourth column 18 on the row corresponding to the row in which the patient is represented located in an examination room. By the use of the term “clicks” or “clickable” in this description is meant any use of an input facility of the computer system which is operatively communicative with the common area or hallway visuals display 10. Such input facilities may be a keyboard, a mouse, a microphone (with use of speech to instruction software), a touch screen display in which the display is the staff display, which display 10 may be on a computer monitor 6 as shown in FIG. 1, or on a tablet P.C., or on a handheld device such as a Palm PDA or Pocket P.C. with a touch sensitive display and a wireless connection to the computer system running the common area display.

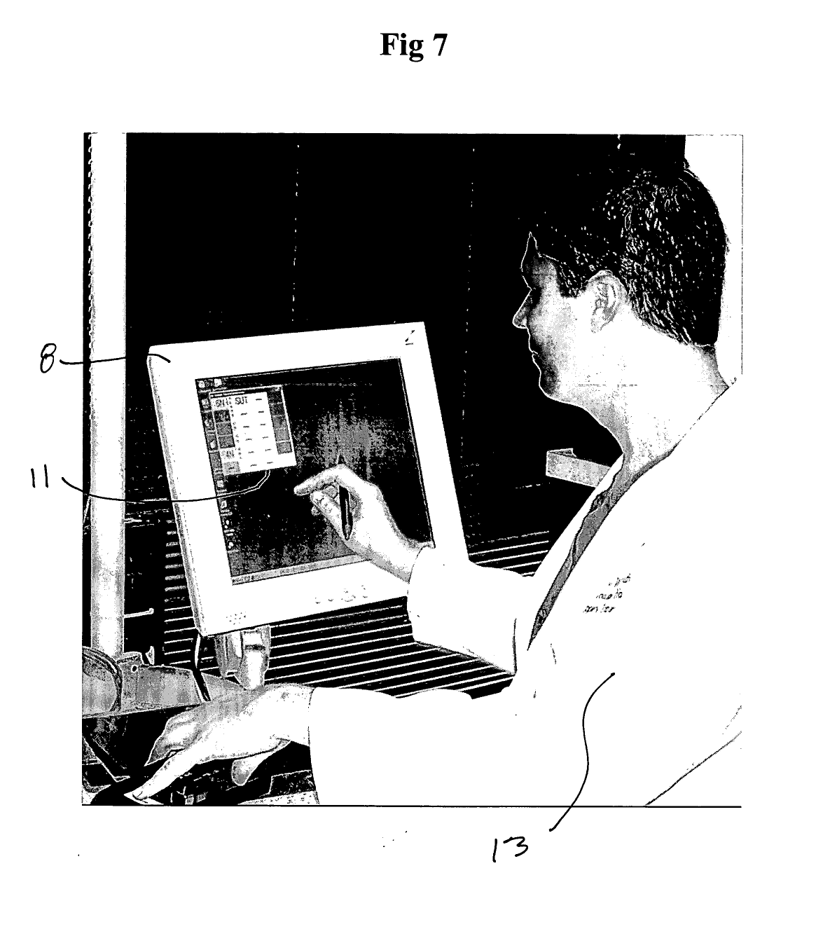

FIG. 7 illustrates the use of a touch sensitive screen display 11 on a staff or examination room monitor 6 by a physician 13 as the input facility for inputs to the visuals display 10. The touch sensitive display 11 senses contact by a user in regions of the touch sensitive display, the regions corresponding to cells in the visuals displays 10 of the hallway monitors 8. As seen from FIG. 7, display 11 in the examination room or in the staff office need not occupy the entire screen area because there is no need for discernment of the alphanumeric characters at a distance. Thus display 11 may be moved on the monitor screen as desired. It also may be locked into a specific part of the screen as desirably may be the case when display 11 is integrated with a PM and EMR system, which may occupy a fixed area of the screen.

To illustrate issuance of a task to a nurse or technician, in which the physician 13 clicks the physician's cell in the fourth column 18 on the row corresponding to the row in which the patient is represented located in an examination room, assuming the examination rooms are in a pod B, this would be cell (x₂y₄) for a patient in examination room #2. Clicking (touching, as depicted in FIG. 5) on that cell (x₂y₄) in display 11 brings up a menu of task requests. An example of a task box 33 is shown in FIG. 6. Task box 33 notifies that it is for pod B, exam room 2 in the task box header 34. These tasks are listed as checkboxes, since multiple tasks are likely issued at one time. In FIG. 6, the tasks above the divider bar 34 are tasks for the second column 14 and the tasks below bar 34 are for third column 16. Any of the tasks can have a ready state, which may be shown with a green background for the text abbreviation. There suitably are two ways to input the ready state: one to add a “ready” button next to the task, as shown on FIG. 6 on this menu; or two, to default the first click on the task in the second or third column to be the ready state, and thus this task is cleared only if it's clicked again. Both of these methods are available to the user, since they would use them for different purposes (accuracy vs. convenience). The system prevents the physician from clicking on the fourth cell if the first cell is not in the treatment status. This limitation can be turned off by the clinic's administrator.

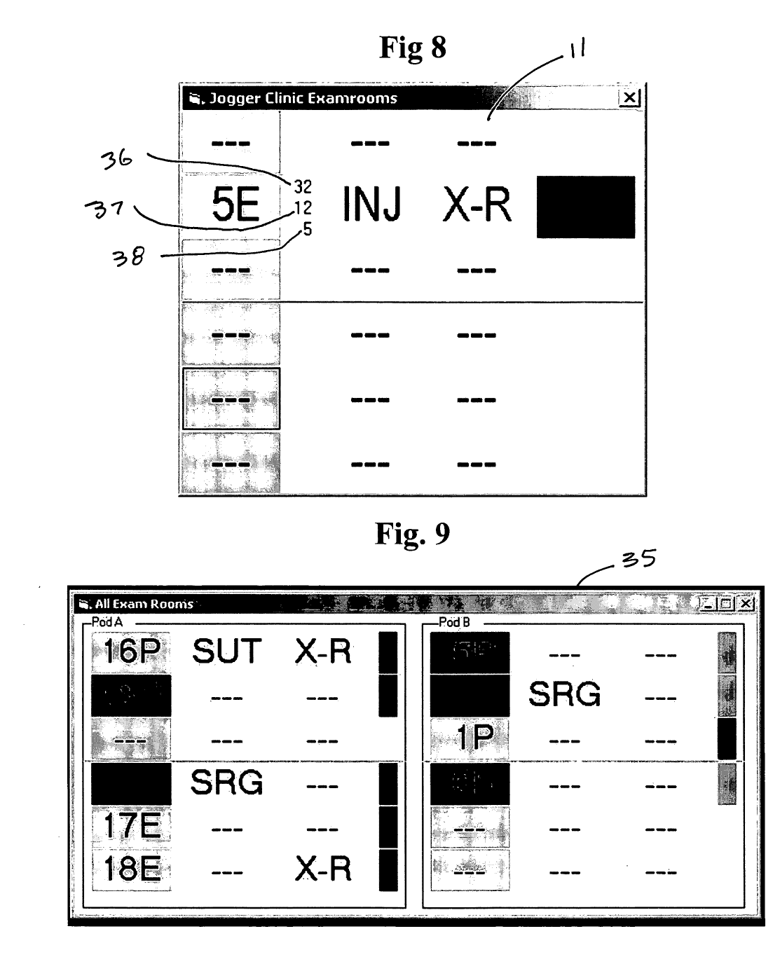

Each time an input is made in any of the four columns 12, 14, 16 or 18 on display 11, the information of the input is recorded in the system's database 3A. Based on these inputs of information, duration of various events can be calculated and displayed. As depicted in FIG. 8, at reference numerals 36, 37 and 38, three such prominent 3-digit timers are positioned immediately to the right of the first cell in display 11, and are vertically stacked on top of each other. The default setting of these three timers is described here, but they can be anything the users collaborating with the designer choose. In this embodiment, the top timer 36 shows the time since the patient was checked in (32 minutes). The second timer 37 shows the time since the patient has been waiting for the physician, namely from the time the room status became red (12 minutes). The third timer 38 shows the time since the physician started treatment (5 minutes). Similarly, timers can be added to the right of the other columns. For example, two timers may be added to the second and third columns (not shown). The top timer would show the time since the task was ordered, and the bottom timer would show the duration of the task being performed. For the fourth column, one timer may be added to show the time since the last time tasks were requested by the physician.

All these timers may be on either the staff or examination room display 11 or on a multi-pod display described below. However they are not generally appropriate for the hallway display 10 for at least two reasons. One, the timers would take up valuable space on the hallway display, where everything has to fit in one monitor. Two, they would be too small for viewing at a distance. Another reason is that the numbers are for staff information and the clinic probably may not want the patients to see these timers.

While the software behind display 10 is the same for all exam rooms, this software must know which exam room it is currently representing. One way to achieve this is to detect, recognize, and use the computer name in the system. In addition and if the user chooses, a slim margin is added to the left of the display, where a marker, say a star, is shown next to the row representing a particular exam room.

Depend on the user's choice, either the whole display 11 (all six rows) or only the row representing the particular exam room for which the physician is making task assignments is enabled for input and control (meaning the buttons are clickable). When the whole display 11 is enabled, the physician can issue task requests for one exam room while inside another.

In a clinic with multiple pods, there is suitably added to the header or the margin of the display 11 a drop-down pick list, labeled tabs, or a set of radio buttons, so that the user can quickly switch between different pods. FIG. 9 depicts an example of a multi-pod display 35. The label of display 35 shows the name of each pod. For a multi-pod display 35, the basic status display is duplicated by two, or three, or more times, but each display represents one unique pod in a multi-pod clinic. These are arranged in one larger window, therefore to achieve a multi-pod display of all the pods in the clinic. Each individual display is labeled with the name of the pod. This naming feature is user controlled. The multi-pod display 35 normally is a read-only display. Optionally, however, the clinic can chose to use the multi-pod display 35 as the interface to issue or respond to task requests. If so, the functions of the staff display 11 are duplicated in each of the pods in the multi-pod display 35. The user's permissions are appropriately applied to each pod. In addition, suitably there is built-in safeguard to limit the non-physician staff's ability to act on the buttons in the pods that the staff member is not allowed to access.

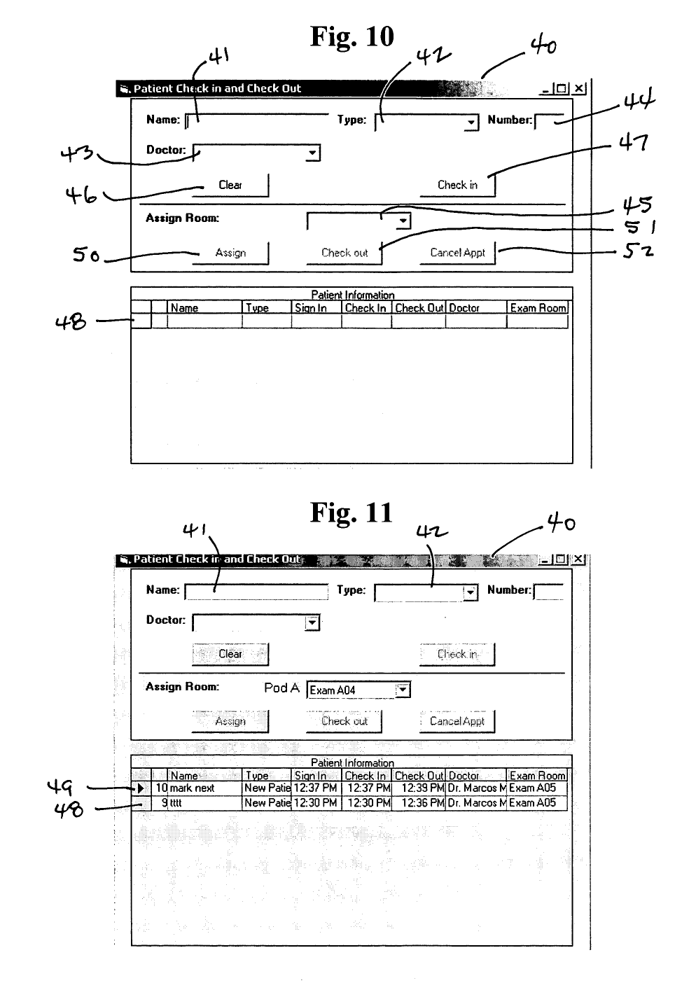

A separate patient module window 40 provides a way for the staff to enter patient information and assign a patient to an exam room. A sample design of this window is depicted in FIG. 10. This window 40 contains data fields for patient name 41, patient type 42, scheduled physician 43, reference or patient number 45, and available exam rooms 45. The reference number 45 is automatically calculated with an increment of one for each physician. Suitably each day the reference number starts at one. Reset is selectable by the clinic. For example, the clinic may restart the reference number 45 from one after lunch each day, or at any time. In addition, the automatically generated reference number 45 can be overridden by the staff at any time.

The physician field 43 is a drop down list of physician names. The exam room field 45 is also a drop down list; however, it only shows available rooms, and therefore is updated by the system very frequently, for example, every three seconds, to reflect the real time status of all rooms.

There is a “clear” button 46 in patient window 40 clearing the data. There is a “check-in” button 47 to save the patient data and record the check-in time in the system's database. Once saved, this patient is listed on one row, e.g. row 48, of a table under the above data fields and buttons. As more patients are checked in, all of them are listed in the table in reverse chronological order, namely the most recent arrivals are on the top, as depicted at 48,49 in FIG. 11. This table shows the patients info, the scheduled physician, the check-in and check-out times, and the room to which the patient is assigned.

Immediately after a patient is checked in, this patient module suitably sends a print job to an external label printer (not shown). A paper ticket is printed with patient's reference number, the time of the appointment, the physician's name, and any other clinical information such as a logo. This ticket is given to the patient as a reminder.

Meanwhile, the patient module has the option of sending a message to one or more designated computers running the staff display 11. The staff display 11 computer may compose a message, which is then read out loud via text-to-speech capabilities of the computers in the staff work area. The composed message may say, for example, “Patient number: A20, has arrived to see Dr. Anderson at 10:30 a.m.”

Optionally, instead of having the system automatically assign a patient to an empty examination room, the staff may uses a staff display 11 running in a window on their computers and select an empty room. For example, the pod's nurse may examine the staff display 11 (FIG. 5) to find an empty room (e.g., cell x₄y₁ which is green [empty], no patient identification number in the cell), then select patient module 40 running as a window on the nurse's computer monitor, then select a patient's row 49, for example, then from drop down list 45 select the room shown empty on the nurses' staff display window, and finally click on an “assign” button 50 to record the assignment. Once assigned, the table in the patient module gets updated with the new information, and a message about the assignment is sent to the waiting room display, described below. At the end of the treatment process, when the patient is checking out of the clinic, the check-out staff member selects the patient from the patient module window 40, and clicks on “check-out” button 51 to record the time in the database. There is also a “cancel appointment” button 52 to completely delete the record in the table of records on patient module 40.

Alternatively, this patient module can be merged with the staff display 11, the exam room display 11, and even the multi-pod display 35. The data fields, buttons, and the table of module 40 are added to the right of these displays. In this format, the patient module 40 shows the patient information when the user selects any one of the rooms in the pod. To do so, a margin area is added to the left of the status display, allowing the user to click in this area to select the room. When a room is selected, an unfilled circle is shown in the margin to indicate the current selection. For the row that represent the current exam room, the circle surrounds the star. Anytime the physician clicks into another room to issue orders, the circle will automatically jump to that row.

Instead of manually entering the patient information, and checking in and out the patient, the system can interface with the clinic's practice management (PM) system. The patient module 40 frequently queries the PM's database 3B for the indications of checking in an appointment and/or creating an encounter. Once detected, module 40 retrieves the patient and encounter information and stores them into the system's database 3A. Specifically, the patient module 40 lists the patient in the table in the patient module 40, sends the ticket print job to the label printer, and records the check-in time. Similarly, when the patient is checked out in the PM system, module 40 updates the table in the patient module 40 with the check-out time. Since PM systems differ from each other, the system must provide the above basic features and capabilities, while the specific querying is customized for each PM system.

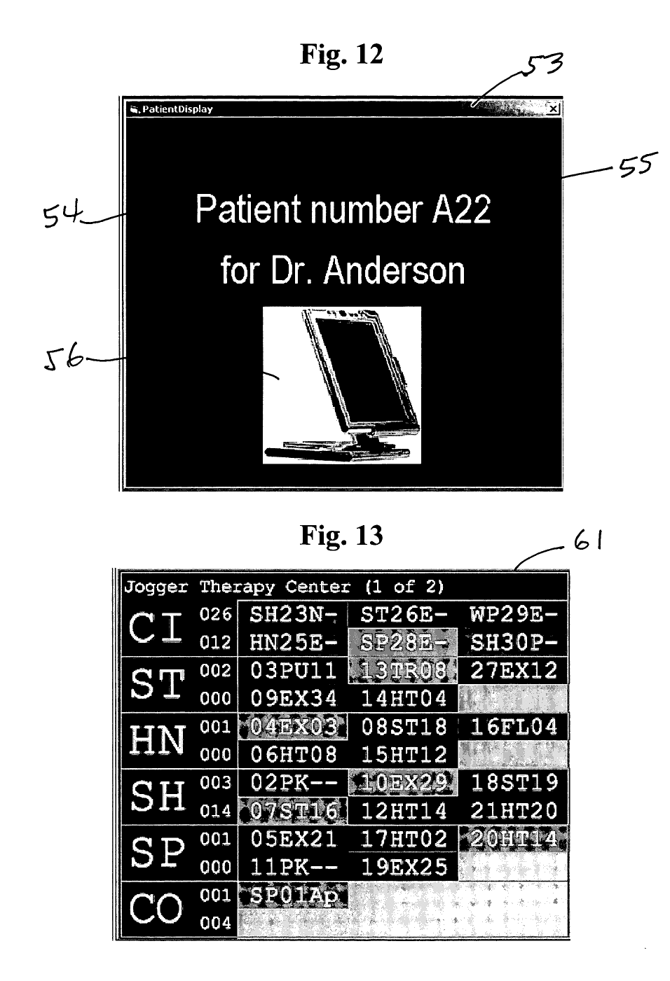

Referring to FIG. 12, an informative multi-media window 53 is depicted. Information window 53 is displayed on the waiting room monitor 5 for the patients to see and hear. The top half 54 of this display 53 shows a fixed greeting message or the name of the clinic. Immediately below are two lines of dynamically changing text message 55 that show the treatment queue in the clinic. For example, message 55 might say, “Patient number: A20 for Dr. James Doe”, or “Dr. James Doe is treating patient #A20”. When patient module 40 sends the room assignment message to information display 53, a display program composes a message, which is then read out loud via text-to-speech capabilities of the computer for the waiting room. The composed message might say, for example, “Patient number: A20, please come into the clinic and meet your nurse in exam room 5.” The bottom half 56 of display 53 is allocated to show multi-media content. Software manages and displays this content. The content 56 may be, for example, house advertisements, educational materials, and commercial advertisements. These contents are dynamically organized, sequenced, and displayed. The system has the ability to manage the placements of ads and to track their showing. The advertising module runs in the background of the clinic's computing environment, constantly receives new content from the company server and returns the usage information to the server.

Another embodiment of this invention is resource properties centric. In this embodiment, the fundamental system is rearranged into a horizontal status display, where the resources are listed in rows, and the subjects are shown in columns on the row. As is illustrated in this embodiment, each cell in a display can also be split into sub-cells, either horizontally or vertically, in order to show more information. In the case of the horizontal status display, the cell is split vertically in half, so that there are two sub-cells one on top and one at bottom. By cutting the letter height in half, display can be comfortably 6 to 7 characters in each sub-cell, which allows a combination of three two-letter abbreviations, optionally with short dashes in between. However, in this design, for a 17 inch monitor, the visibility distance reduced to less than 30 feet. For nomenclature purposes, a split cell is identified by the usual x, y coordinates preceded by U for upper half of the split cell and L for the lower half of the split cell.

Referring to FIG. 13, there is depicted a horizontal status display 60 which is employed in a computerized resources utilization management system of this invention. The system has at least a pair of visuals displays 60, 61, 60 being one in a common area analogous to the hall display 10 for the vertical status monitor 10, and another a staff display 61, as for the medical clinic staff and examination room monitor vertical status displays 11, used for inputting information in cells. The horizontal status displays 60 show computer generated visuals expressing the status in real time of at least some of a plurality of objects in a predetermined arrangement within a pattern of a plurality of such arrangements, as in the vertical displays, and also as in the vertical status displays, the arrangement comprises a row and the pattern comprising vertically stacked rows forming columns of cells in a grid of rows and columns. One such object comprises a patient and the other objects comprises at least one defined resource or defined properties of at least one resource, or both, at least one of the one or more defined resources or the one or more defined properties of resources, or both, being selectively available for assignment to the subject by one or more users.

More particularly, with reference to FIG. 13, the rows identify resources. At least one of the rows contains cells for temporary placement of patient identification objects. Thus in FIG. 13, the first row 62 identifies a space resource (e.g., a waiting room resource), identified in the first column 63 as having the subject matter CI. Using a 17 inch flat panel display, the number of columns is limited to four as explained above in connection with the vertical status display embodiment. Although the split of cells in the first row 71 allows six sub-cells, a virtual portion of the waiting room is held in computer memory until space opens in the visible representation of the wait room on display 60. The intersections of the second, third and fourth columns 64, 66 and 68 with the first row identify cells in which subject matter (e.g. patients) are represented in the upper half of split cells (Ux₂y₂, Ux₂y₃, Ux₂y₄) in row 71 and in the lower half of split cells (Lx₂y₂, Lx₂y₃, Lx₂y₄) in row 71 for temporary placement of patient identification objects.

At least one of the resources in horizontal status display 60 is an extent of space at least sufficient for occupancy of the patient for use of resources by or for ministration of services to the patient. At least one or more other rows in the pattern includes cells each representative of an extent of space resource to which a patient can be moved, which space resource is at least sufficient for occupancy of the patient and for designated other resources or properties of resources for use of resources by or for ministration of services to the patient at such space resource, each row representing a differently designated resource or property of a resource.

This embodiment can apply, for example, to a physical therapy operation, where therapy is a property of a resource which is a physical therapist, and is performed at a plurality of stations defined principally by the task to be performed at the station. The patient is moved from task station to task station, rather than having all the tasks being performed at one space resource, as in the spec resource centric medical clinic embodiment. A resource also may be equipment used by the patient. In the explanation of the horizontal status display and its use which follows, certain abbreviations are used in the drawings and in the description, as follows: HN=hand, SH=shoulder, SP=splint, ST=strengthening, CO=check-out, WP=whirlpool, BT=BTE, PU=pulleys, weight wells=WW, cycle=CY, fluidotherapy=FL and IR=insurance rating. The “Ap” in the CO area cell means that a staffer therapist wants the check-out staff to schedule additional appointment for this patient's return visits. The clinic can have as many tasks as they want. The ones explicated here are merely examples. In this format, different physical therapy staff members are assigned colors, for example, staffer #1 is rose, staffer #2 is blue, staffer #3 is dark red, staffer #4 is orange, and staffer #5 is green. A convention is used where a patient is identified in the wait area by the treatment the patient is to get (e.g., HN, SH, etc.), by the patient number, by a characterization of the patient (N=new, E=established, P=post operative, etc.). Thus patient HN23E-is an established patient number 25 scheduled to receive treatment on a hand.

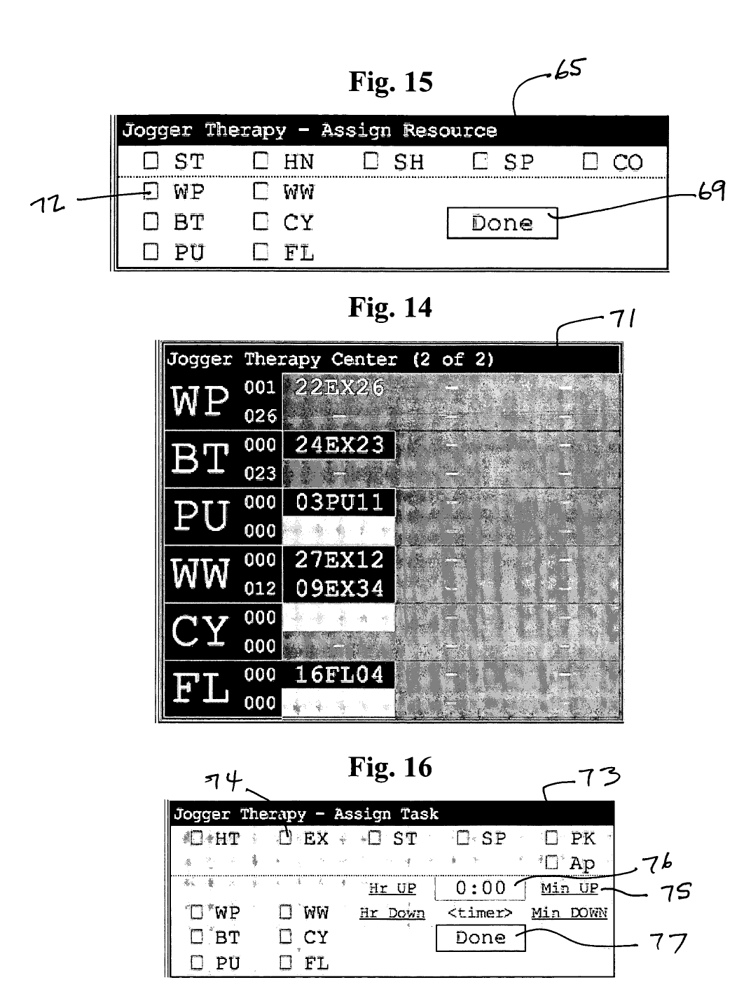

For assignment of a patient in CI to a vacant treatment space in HN area, a staffer does one-click in display 61 on the patient's sub-cell Lx₁y₂ in CI row 62. The system brings up an “Assign Resource” window 65, depicted in FIG. 14. The staffer one-clicks on the HN checkbox 67 in Assign Resource window 65, then one-clicks on the “Done” button 69. The system closes window 65, removes the patient cell (say HN25E-) from the CI area in displays 60 and 61 and moves up the rest of the patient cells in displays 60 and 61 in the CI area per an up-then-left pattern, then displays “25 - - - ” in the empty cell in the HN area of displays 60 and 61. The last two characters in the six character message inside the cell represent a place for an active timer. When a cell does not have an active timer in the last two characters in the six character message inside the cell, this cell is ignored by the timer of the area that calculates “minimum time to next available space in this area.”

FIG. 15 depicts a visuals display screen 70, 71 for special equipment locations and is the second part of the display 60, 61. When a staffer needs to move the patient to a special equipment area, the staffer one-clicks on the left portion of the patient cell on display 61, namely the area comprising the first two characters. The system brings up Assign Resource window 65. The staffer one-clicks on one of the six equipment checkboxes (WP, BT, PU, WW, CY, FL, etc), as e.g. at 72, then one-clicks on Done button 69. The system copies the patient cell to display screens 70, 71 in the available space in the equipment area.

When the staffer is ready to start the patient on an exercise for 20 minutes, the staffer one-clicks on the right portion of the cell for the patient in either display 61 or 71, the right side being the area comprising the last four characters of the cell on the right. The system brings up the Assign Task window 73 depicted in FIG. 16. The staffer one-clicks on EX checkbox 74. The staffer then double-clicks on “Min UP” button 75. A single-click increments time by one minute, a double click increments time by 10 minutes. With a double click, the system shows 0:20 in timer box 76. The staffer then clicks on “Done” button 77. The system closes window 73, displays “25EX20” in this patient cell and the system starts to count down the timer. When timer 76 reaches “00”, the patient cell flashes for five seconds, then displays “25EX00” until the staffer reopens this window and deselects “EX,” then clicks Done button 77. The system then again displays “23 - - - ” in the patient's cell.

One or more cells in said row including said patient identification cell includes one or more elapsed time indicators representing time progression of status changes As with the embodiment discussed for the vertical status display, a computer system operably communicative with a the horizontal status visuals display for communicating inputs to the display, the system including at least one input facility for taking such inputs, such inputs including identification of the patient and inputs assigning resources and properties of resources to the patient, the input of identification of the patient being placed in a cell of the row which includes the cell for extent of space resource. Suitably the computer system comprises a network of computers, at least one computer of which has a resources management database for recording creation of a subject record and events of input to the display.

For data structure as used in the system of this invention, a status table contains the current status of all pods of the clinic, including the background color of each cell, the messages in each cell, and the timer data. This table is used to efficiently construct the various status displays in the clinic, minimizing the need to recalculate many data points.

Suitably there is a separate task/status reference tables for each class of resources. For example, one for room status, listing all the colors, their meaning, and their sequence of events; and another for all the tasks a nurse can perform, along with which task has the ready state. Alternatively, all such tables can be combined into one table, using a category field to indicate different resources.

Suitably there are separate historical record tables for each class of resources. For example, one for room status, listing all changes including time stamp information. Specifically, this type of records must contain the following data points: task index (record ID), subject reference (patient), task reference, order date-time, start date-time, restart date-time, stop date-time, duration time, status reference, PM reference, EMR reference, and resource reference. The duration time is updated each time the task is stopped, either temporarily or at final completion. For performance concerns, a combined table for all historical records may not be preferred.

Suitably there is a room configuration table for the location and the use of each computer in the clinic. This table tracks the designated computers for each exam room or each nurse workstation. A separate clinic configuration table is needed to record the various clinic-level choices, such as permissions, display arrangements, and refresh frequencies.

Other miscellaneous tables are used to store physician information, patient information, patient characteristics, and appointment/encounter information.

One or more tables is suitably used to handle the multi-media contents of the advertising module. In addition to the raw content, these tables store usage information, such as a record of show frequency, duration, and location. A separate table is needed to track the history of uploads and downloads of the content and usage data to a company central server.

A use of the computerized resources utilization management system is involves inputting by a the input facility an identification to a subject and an assignment of an extent of space resource to the identified subject, causing the visuals display to display a representation of the identified subject in the assigned extent of space; placing the identified subject in the assigned extent of space; inputting by a the input facility a selection of at least one property of at least one resource for application to the identified subject, causing the visuals display to display a representation of each such resource property or properties selected for application to the identified subject; applying a selected property of a selected resource to the identified subject; inputting by a the input facility a completion of application of a resource property selected for application to the subject identification, causing the visuals display to display a representation of completion of application of such resource property selected for application to the subject identification; repeating the next preceding step until all selected properties of all selected resources have been applied; removing the identified subject from the assigned extent of space, and inputting by a the input facility a lack of occupancy of the assigned extent of space, causing the visuals display to display a representation of lack of occupancy of the assigned extent of space.

Thus is a broad sense, a patient makes an appointment with the clinic, which is recorded in the PM system. This system is aware of the pending appointments, including all related information. The patient checks in to the clinic by verbally greeting the receptionist. The receptionist checks in the appointment and creates an encounter in the PM and EMR systems. This system detects the creation of the encounter in the PM and EMR systems, thus creates a reference number for the patient, and then outputs to a thermal printer a ticket, which shows the reference number.

As the patient waits in the lobby, this system's software runs on a computer screen, which shows the status of the patient queue in the clinic, along with multi-media content. Meanwhile, the clinic's nurse detects the arrival of the patient, and thus looks at this System, which is running on the nurse's computer, to find an empty treatment room. Each room takes up a row on the display, which consists of four columns or cells of large lettered abbreviations. These cells can display different background colors, which represent additional meanings. When the background of the first cell is green, this particular room is an empty room. Once available, the nurse uses this system to assign the patient to this room. Immediately, the lobby computer speaks out an announcement that directs the patient to the exam room. At the same time, the patient's reference number is displayed in the first cell, along with a letter indicating the type of the patient. When the nurse first greets the patient in this room, the nurse click once in this system to change the status of the room, as represented by a different background color of the first cell, which records that the nurse has started to treat the patient. The nurse can summon the help of a physician by changing the status of this room. When the physician comes into the room, the physician also clicks once in this system to record the start of his work. In order to issue orders to nurses, lab or x-ray technicians, or administrative staff, the physician uses a few clicks in this system to issue the requests. Immediately all other displays of this System in the clinic show the change in the room status and the requested tasks for nurses and technicians. Optionally, this system can page the staff or to announce the request on load speakers.

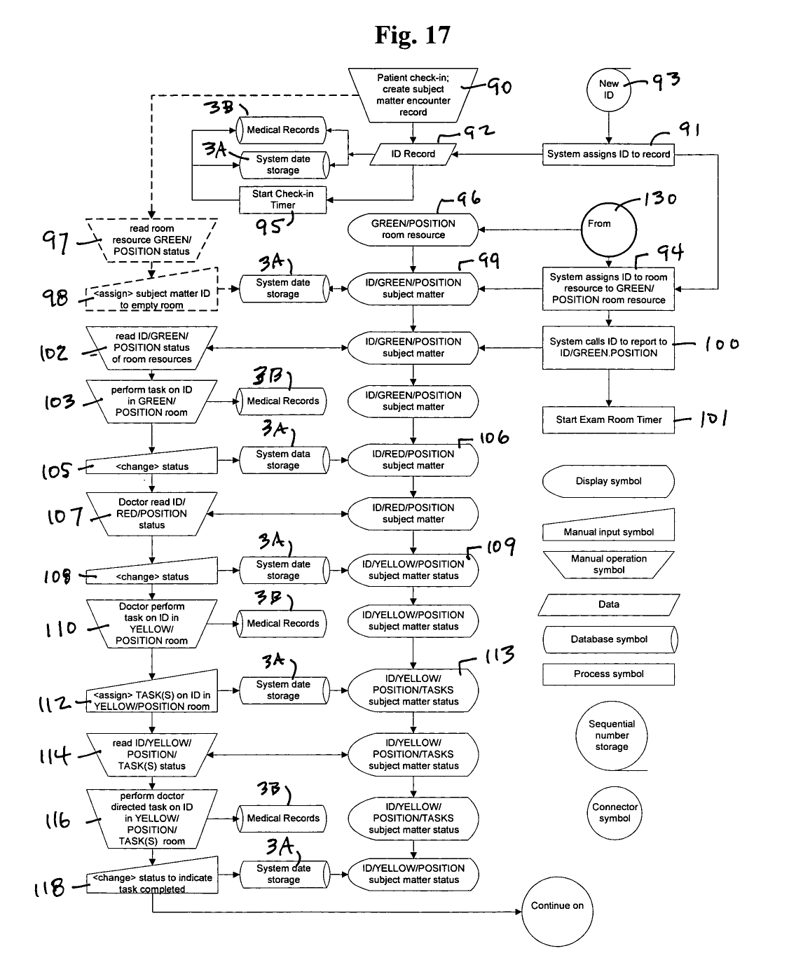

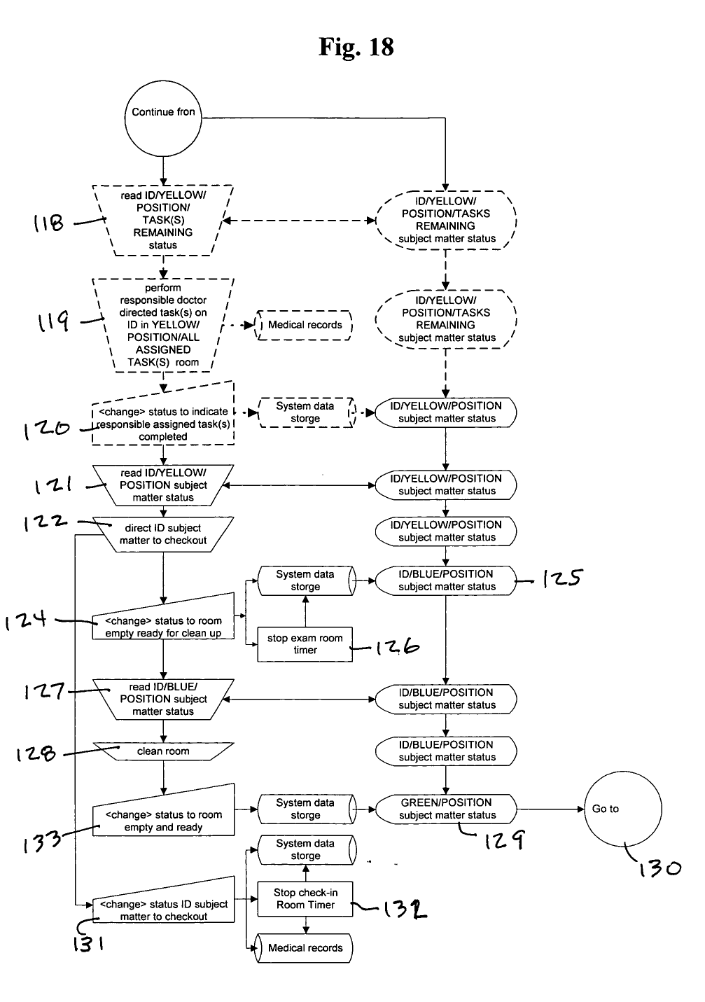

Referring more particularly to FIGS. 17 and 18 in conjunction with FIG. 1, a computer record for the patient is opened at 90 with admissions computer workstation 4, the computer system at 91 assigning an identification 92 from sequential number provider 93 to the patient, the computer 4 communicating with a network server 2 and polling a system database 3A accessed by server 2 in the network for an empty examination room and assigning at 94 a found empty room GREEN/POSITION to the identification in record 90. As discussed above a PM database 3B may be accessed to drop in information in the record through patient module 40. Opening the record 90 and identification 91 starts check-in timer 95. Alternatively (as indicated by dashed lines), as explained above, a staff member may read a room resource GREEN/POSITION status 96 on the staffer person's display 11, as indicated at 94, and <assign> (the “<” and “>” indicate a computer input facility, such as a keyboard, mouse or touch screen) the patient ID subject matter to the empty GREEN/POSITION cell, as at 98. The <input> either by at the receptionist workstation 4 or at the staff workstation display 11 enters the ID into the GREEN/POSITION cell, as at 99, changing displays 10 (hall) and staff and examination room displays 11 to show change in status of empty GREEN/POSITION cell 96 to ID/GREEN/POSITION cell 99. This data is transmitted over the network to the system data storage 3A. At the same time the system places a call display notice 100 on the waiting room monitor 5 and by text to speech software calls the patient by the identification number for the assigned doctor and starts a timer, as at 101, for examination room ID/GREEN/POSITION cell 99. A staff provider either notified of patient ID by a computer notice or page or from reading the ID/GREEN/POSITION on a display 10 or 11, as at 102, directs the patient to the empty room ID/GREEN/POSITION assigned to the identification number.

In room ID/GREEN/POSITION, the provider, such as a medical assistant or nurse, may conduct pre-examination services to the patient having the identification in the room, as at 103. The information is entered into the patient's medical records by the examination room computer, as at 104. After completing the set-up for the doctor, the provider person <inputs> into a computer input device (suitably a touch screen examination room display 11) communicating with the network a change of status of the examination room, as at 105, to signify a doctor is needed in the room associated with the patient identification, the status being presented on the passageway display 10 and the staff and examination room displays 11, as at 106, where ID/GREEN/POSITION changes to ID/RED/POSITION. The doctor needed ID/RED/POSITION status is read by a doctor from the passageway display 10 or the staff and examination room displays 11, as at 107. The doctor enters the examination room signified by the POSITION in the ID/RED/POSITION cell of the displays and <inputs> into a computer input device (such as the touch screen display 11 in the examination room) as at 108, as by depressing the exam room cell to cycle the cell color to YELLOW, to indicate that the patient is no longer waiting on the doctor and treatment is beginning in that room. This changes the cell for that room in the displays from ID/RED/POSITION to ID/YELLOW/POSITION at at 109 and send the same data to the system data base.

The doctor provides patient services to the patient having the identification in the room, as at 110, communicating those services by computer to electronic medical records, as at 111. If any tasks are to be performed for treatment of the patient by a health care provider person or persons other than the doctor, the doctor, as at 112, <inputs> into a computer input device communicating with the network an order of any such tasks to be performed, as was explained above in connection with FIGS. 5, 6 and 7, the tasks being signified by a code, the code being presented on all display devices 10 and 11, depicted symbolically in FIG. 17 by ID/YELLOW/POSITION/TASK at 113.

Reading ID/YELLOW/POSITION/TASK from the passageway display 10 or a staff display 11, a task provider health care person dutied to perform a task ordered by the doctor sees the task needed status of the identification associated with the room which the patient occupies, as at 114, and provides patient services to the patient having the identification in the room, the person providing the services tasked to the person by the doctor and presented on the display, as at 116, which are communicated by the examination room computer to medical records, as at 117. After completing an ordered task, the task provider <inputs> into a computer input device (suitably a touch screen of the examination room display) communicating with the network a change in status, clicking off the task to clear it from the display, as at 118, which also transmits the status data to the system database 3A. This is repeated until all tasks are performed by all responsible for the doctor assigned tasks, as indicated by the dashed lines for steps 118-120 shown in FIG. 18, leaving the cell on displays 10 and 11 as ID/YELLOW/POSITION.

The doctor at 121 reads from the passageway display 10 or an office or another examination room display 11 that all tasks are cleared from ID/YELLOW/POSITION and enters the examination room and discharges the patient, directing the patient to checkout at the admissions desk, as at 122. The patient proceeds to checkout as at 123. The doctor <inputs> into a computer input device communicating with the network a change of status of the examination room, as at 124, from ID/YELLOW/POSITION to ID/BLUE/POSITION (at 125) to signify completion of treatment in the room associated with the patient identification, the treatment completed status being presented on the passageway display 10 and the staff and examination room displays 11 (125) and entered into system database 3A. The change to BLUE status stops the examination room timer, as at 126.

A staff person reads the display 10 (or 11) as at 127 and proceeds to room ID/BLUE/POSITION cleans the examination room identified as ID/BLUE/POSITION, as at 128. The staff person <inputs> a change of status on the examination room input facility (touch in the blue cell on the display) and cycles the cell color to GREEN for a cell status of GREEN/POSITION, as at 129. This information is sent to system data storage and the room is show empty and available at 130. Meanwhile the patient is <checked out> at 131 using patient module 40 at the admissions desk, which stops the check-in timer at 132 and the data from the patient's record is sent to system database 3A and the medical records practice management database 3B.

The effect is an environment where all clinicians, staff and physicians, can at any moment take a glance at this System and know the status of each exam room, and know if they are needed to perform certain tasks. For the most critical clinicians, such as the physicians, they can use this System to manage their workflow, thereby avoiding wasting precious time waiting for the nurse to tell him where to go next.

From the foregoing description, it will now be appreciated that the system and methods of this invention have benefits which include: masking patient identity during a clinical or hospital visit (protection of privacy under the Health Insurance Portability and Accountability Act of 1996), enabling ubiquitous communication of workflow status across an organization; enabling immediate communication of workflow requests to the rest of the organization; enabling immediate communication of task progress and completion; enabling real-time prioritization of tasks for all resources of the organization, thereby allowing real-time de-bottlenecking of the organization's operations; enabling accurate analysis of operational activities and employee productivity; saving time by shortening task communication and planning, thereby improving operational efficiency and increasing operational capacity; providing an intuitive status display and input interface; providing a dynamically arranged status display and input interface; providing customized timers to aid the users in controlling patient wait times in a clinic; and enabling clinics and hospitals to directly record operational status and manage teamwork.

Having described the invention in part by specific embodiments, it is to be understood that the invention is not limited to the specific embodiments but is as pointed out in the appended claims and the equivalents of elements in the claims.

I claim:

1. A computerized resources utilization management system, comprising:
a. a visuals display device for displaying computer generated visuals expressing the status in real time of at least some of a plurality of objects in a predetermined arrangement within a pattern of a plurality of such arrangements, one such object comprising a subject occupying space and the other objects comprising at a plurality of one or more resources or one or more properties of one or more resources, or both, at least one of said one or more resources being an extent of space at least sufficient for occupancy of said subject, and at least one other of said one or more resources or said one or more properties of resources, or both, being selectively available for assignment to the subject by one or more users,
b. a computer system operably communicative with said visuals display for communicating inputs to said display, said system including at least one input facility for taking such inputs, such inputs including at least identification of the subject and inputs assigning resources and properties of resources t to the subject.

2. The management system of claim 1 in which said subject is a patient.

3. The management system of claim 1 in which others of said resource objects include human resources, at least one of which is a health care provider.

4. The management system of claim 1 in which said arrangement is a row and said pattern is vertically stacked rows forming columns of cells in a grid of rows and columns.

5. The management system of claim 4 in which each row includes a cell in one column representative of said extent of space resource.

6. The management system of claim 5 in which the subject is a patient and said input of an identification of the subject is an identification of the patient and is placed in a cell of a row which includes a cell for an extent of space resource and cells for resources or properties of resources, or both, for the identified patient.

7. The management system of claim 6 in which the cell in which said patient identification is placed also represents extent of space resource.

8. The management system of claim 7 in which said extent of space resource is a bed.

9. The management system of claim 7 in which said extent of space resource is a room.

10. The management system of claim 6 in which said resources include a physician, a medical assistant and a non-medical assistant, properties of the medical assistant resource include medical treatments assignable by such physician, and properties of the non-medical technician include non-medical tasks assignable by the physician.

11. The management system of claim 6 in which one or more cells in said row including said patient identification cell includes one or more elapsed time indicators representing time progression of status changes.

12. The management system of claim 4 in which the subject is a patient, said input of an identification of the subject is an identification of the patient, said patient identifications are input for inclusion in one or more rows containing cells representative of a wait area for patients, and in which cells in at least one or more other rows in said grid are each representative of a resource or properties of a resource to which a patient can be moved, which space resource is at least sufficient for occupancy of said patient and for other resources or properties of resources for use by or ministration of services to the patient at such space resource, each row representing a differently designated resource or property of a resource.

13. The management system of claim 12 in which said other properties of resources comprise specified treatment locations.

14. The management system of claim 12 in which said treatment locations comprise locations for therapy ministration.

15. The management system of claim 12 in which one or more cells in said row including said patient identification cell includes one or more elapsed time indicators representing time progression of status changes.

16. The management system of claim 1 in which said input facility is a touch sensitive display separate from said visuals display, said touch sensitive display sensing contact by a user in regions of the touch sensitive display, said regions corresponding to cells in said visual display.

17. The management system of claim 1 in which said visual display is located in an area near the space resources represented by cells in said column representative of space resources.

18. The management system of claim 1 in which said computer system includes a network of computers, at least one computer of which has a resources management database for recording creation of a subject record and events of input to said display.

19. The management system of claim 18 in which one or more of said inputs signify billable medical services.

20. The management system of claim 19 in which said network is integrated with practice management and electronic medical records databases, whereby said inputs which signify billable medial services are recorded in the appropriate one or both of said practice management and electronic medical records databases.

21. A computerized resources utilization management system, comprising:
a. a visuals display device for displaying computer generated visuals expressing the status in real time of at least some of a plurality of objects in a predetermined arrangement within a pattern of a plurality of such arrangements,
i. said arrangement comprising a row and said pattern comprising vertically stacked rows forming columns of cells in a grid of rows and columns,
ii. one such object comprising a patient and the other objects comprising at least one defined resource or defined properties of at least one resource, or both, at least one of said one or more defined resources or said one or more defined properties of resources, or both, being selectively available for assignment to the subject by one or more users,
iii. at least one of said resources being an extent of space at least sufficient for occupancy of said patient, said resources also including a physician, a medical assistant and a non-medical assistant, properties of the medical assistant resource including medical treatment tasks assignable by such physician, and properties of the non-medical technician including non-medical tasks assignable by the physician,
iv. each row in said pattern including
1. a cell in one column representative of said extent of space resource,
2. a cell in another column representative of identification of said physician resource,
3. a cell in yet another column representative of any tasks for said medical assistant representative, and
4. a cell in still another column representative of any tasks for said non-medical assistant,
b. said visuals display being located in an area near the space resources represented by cells in said column representative of space resources,
c. a computer system operably communicative with said visuals display for communicating inputs to said display, said system including at least one input facility for taking such inputs, such inputs including identification of the patient and inputs assigning resources and properties of resources to the patient, said input of identification of the patient being placed in a cell of said row which includes said cell for extent of space resource,
d. said computer system comprising a network of computers, at least one computer of which has a resources management database for recording creation of a subject record and events of input to said display.

22. The management system of claim 21 in which one or more of said inputs signify billable medical services.

23. The management system of claim 22 in which said network is integrated with practice management and electronic medical records databases, whereby said inputs which signify billable medial services are recorded in the appropriate one or both of said practice management and electronic medical records databases.

24. The management system of claim 21 in which said input facility comprises a touch sensitive display separate from said visuals display, said touch sensitive display sensing contact by a user in regions of the touch sensitive display, said regions corresponding to cells in said visual display.

25. The management system of claim 21 in which one or more cells in said row including said patient identification cell includes one or more elapsed time indicators representing time progression of status changes.

26. A computerized resources utilization management system, comprising:
a. one or more visuals displays for displaying computer generated visuals expressing the status in real time of at least some of a plurality of objects in a predetermined arrangement within a pattern of a plurality of such arrangements,
i. said arrangement comprising a row and said pattern comprising vertically stacked rows forming columns of cells in a grid of rows and columns,
ii. one such object comprising a patient and the other objects comprising at least one defined resource or defined properties of at least one resource, or both, at least one of said one or more defined resources or said one or more defined properties of resources, or both, being selectively available for assignment to the subject by one or more users,
iii. at least one of said rows containing cells for temporary placement of patient identification objects,
iv. at least one of said resources being an extent of space at least sufficient for occupancy of said patient for use of resources by or for ministration of services to the patient,
v. at least one or more other rows in said pattern including cells each representative of an extent of space resource to which a patient can be moved, which space resource is at least sufficient for occupancy of said patient and for designated other resources or properties of resources for use of resources by or for ministration of services to the patient at such space resource, each row representing a differently designated resource or property of a resource,
b. a said visuals display being located in an area near the space resources represented by cells in said rows representative of space resources to which a patient can be moved which space resource is at least sufficient for occupancy of said patient and for designated other resources or properties of resources for use of resources by or for ministration of services to the patient at such space resource, each row representing a differently designated resource or property of a resource,
c. a computer system operably communicative with a said visuals display for operating and communicating inputs to said display, said system including at least one input facility for taking such inputs, such inputs including identification of the patient and inputs assigning resources and properties of resources to the patient, said input of identification of the patient being placed in a cell of said row which includes said cell for extent of space resource,
d. said computer system comprising a network of computers, at least one computer of which has a resources management database for recording creation of a subject record and events of input to said display.

27. The management system of claim 26 in which selected ones of said inputs signify billable medical services.

28. The management system of claim 26 in which said network is integrated with practice management and electronic medical records databases, whereby said inputs which signify billable medial services are recorded in the appropriate one or both of said practice management and electronic medical records databases.

29. The management system of claim 26 in which one or more cells in said row including said patient identification cell includes one or more elapsed time indicators representing time progression of status changes.

30. The management system of claim 26 in which said input facility comprises a touch sensitive display separate from said visuals display, said touch sensitive display sensing contact by a user in regions of the touch sensitive display, said regions corresponding to cells in said visual display.

31. A method of managing utilization of resources, comprising:
a. providing a system comprising
i. a visuals display device for displaying computer generated visuals expressing the status in real time of at least some of a plurality of objects in a predetermined arrangement within a pattern of a plurality of such arrangements, one such object comprising a subject occupying space and the other objects comprising at least one defined resource or defined properties of at least one resource, or both, at least one of said one or more defined resources or said one or more defined properties of resources, or both, being selectively available for assignment to the subject by one or more users, at least one of said resources being an extent of space at least sufficient for occupancy of said subject, and
ii. a computer system operably communicative with said visuals display for communicating inputs to said display, said system including at least one input facility for taking such inputs,
b. inputting by a said input facility an identification to a subject and an assignment of an extent of space resource to said identified subject, causing said visuals display to display a representation of said identified subject in said assigned extent of space,
c. placing said identified subject in said assigned extent of space,
d. inputting by a said input facility a selection of at least one property of at least one resource for application to said identified subject, causing said visuals display to display a representation of each such resource property or properties selected for application to said identified subject
e. applying a selected property of a selected resource to said identified subject,
f. inputting by a said input facility a completion of application of a resource property selected for application to said subject identification, causing said visuals display to display a representation of completion of application of such resource property selected for application to said subject identification,
g. repeating step (f) all selected properties of all selected resources have been applied,
h. removing said identified subject from said assigned extent of space, and
i. inputting by a said input facility a lack of occupancy of said assigned extent of space, causing said visuals display to display a representation of lack of occupancy of said assigned extent of space.

32. The method of claim 31, in which said computer system comprises a network of computers, at least one computer of which has a resources management database for recording creation of a subject record and events of input to said display, and wherein said method further comprises recording inputs of change of status onto said display.

33. A method of managing utilization of resources, comprising
a. providing a system comprising
i. a visuals display device for displaying computer generated visuals expressing the status in real time of at least some of a plurality of objects in a predetermined arrangement within a pattern of a plurality of such arrangements, one such object comprising a subject occupying space and the other objects comprising at least one defined resource or defined properties of at least one resource, or both, at least one of said one or more defined resources or said one or more defined properties of resources, or both, being selectively available for assignment to the subject by one or more users, at least one of said resources being an extent of space at least sufficient for occupancy of said subject, and
ii. a computer system operably communicative with said visuals display for communicating inputs to said display, said system including at least one input facility for taking such inputs, such inputs including at least identification of the subject and inputs assigning resources and properties of resources to the subject,
b. inputting by a said input facility an identification to a subject, thereby causing display of said subject identification on said visuals display,
c. inputting by a said input facility a selection of at least one resource not a space resource and at least one property of such selected resource for application to said identified subject, each property being located in an extent of space resource in said pattern, thereby causing display on said visuals display of a representation of said subject in a representation of said extent of space where said selected property for application to said subject is located in said pattern,
d. placing said identified subject in an extent of space resource where said selected property is located for application to said subject,
e. applying said selected property of a selected resource to said subject,
f. inputting by a said input facility a completion of application of said selected property to said subject, thereby changing the displayed status of said representation of said subject in said representation of said extent of space to indicate completion of application of said selected property to said subject, and
g. repeating steps (e) through (f) until all selected properties have been applied.

34. A method of managing room and health care provider resources utilization for patients, comprising:
a. opening a computer record for the patient, the computer assigning an identification to the patient, said computer communicating with a network,
b. assigning an empty location to said identification,
c. directing the patient to the empty location assigned to the identification,
d. inputting into a computer input device communicating with said network a change of status of said location from empty to occupied, said change of status being displayed on a visual display communicating with said network, said patient identification being associated on said display with the assigned location, said display being located in an area near said occupied location,
e. entry into said occupied location by a provider person to commence provision of services to said patient in said location,
f. inputting into a computer input device communicating with said network a change of status of the location or the patient to signify provision of services has begun in said location, said treatment underway status being presented on said display;
g. provision by a health care provider of services to said patient in said location, said provider, if any tasks are to be performed for the patient by another provider person or persons resource, inputting into a computer input device communicating with said network an order for any such tasks to be performed, a representation of said tasks being displayed on said display;
h. provision of services to said patient in said location by a provider person, said person providing the services tasked to the person by said health care provider and presented on said display, said person after completing an ordered task inputting into a computer input device communicating with said network a change in status removing from said display said ordered task;
i. said next preceding step being repeated for any tasks ordered and not performed by said first task provider health care person, until all ordered tasks are performed; and
j. inputting into a computer input device communicating with said network a change of status of the examination location to signify completion of treatment in said location associated with said patient identification, said treatment completed status being presented on said display.

35. A method of managing resource utilization for a plurality of patient rooms accessed by a passageway, including:
a. opening a computer record for the patient, the computer assigning an identification to the patient, said computer communicating with a network,
b. polling a work flow database on a server in said network for an empty examination room and assigning a found empty room to said identification,
c. calling the patient by the identification number and directing the patient to the empty room assigned to the identification number,
d. presenting said identification on a display communicating with said network, said identification being associated on said display with the assigned examination room, the empty status of such room being signified on the display, said display being located in a passageway communicating with said assigned empty examination room,
e. reading by a first health care provider person the status of said identification associated with an empty room,
f. provision of pre-examination services to the patient having said identification in said room by said first health care provider person, said first health care provider person on completion of services inputting into a computer input device communicating with said network a change of status of the examination room to signify a doctor is needed in said room associated with said patient identification, said status being presented on said passageway display;
g. reading by a doctor from said passageway display said doctor needed status of said identification associated with the room which the patient occupies;
h. inputting into a computer input device communicating with said network a change of status of the examination room to signify a treatment has begun in said room associated with said patient identification, said treatment underway status being presented on said passageway display;
i. provision of patient services to the patient having said identification in said room by said doctor, said doctor, if any tasks are to be performed for treatment of the patient by a health care provider person or persons other than the doctor, inputting into a computer input device communicating with said network an order of any such tasks to be performed, said tasks being signified by a code, said code being presented on said passageway display;
j. reading from said passageway display, by a task provider health care person dutied to perform a task ordered by the doctor, said task needed status of said identification associated with the room which the patient occupies;
k. provision of patient services to the patient having said identification in said room by said task provider health care person, said person providing the services tasked to the person by said doctor and presented on said display, said person after completing an ordered task inputting into a computer input device communicating with said network a change in status removing from said display said ordered task;
l. said next preceding two steps being repeated for any tasks ordered and not performed by said first task provider health care person, until all ordered tasks are performed;
m. reading by a doctor from said passageway display said task completed status of said identification associated with the room which the patient occupies; and
n. inputting into a computer input device communicating with said network a change of status of the examination room to signify completion of treatment in said room associated with said patient identification, said treatment completed status being presented on said passageway display.

36. The method of claim 34 further comprising
reading by a person from said passageway display said treatment completed status presented on said passageway display, said person cleaning the room associated with said treatment completed status, said person inputting into a computer input device communicating with said network a change of status of the examination room to signify said room is empty, said room empty status being presented on said passageway display.

37. The method of claim 34 in which every change of status input into said device communicating with said network enters data signifying said change in said work flow database.

38. The method of claim 34 in which every performance of a task on said patient input into said device communicating with said network enters data signifying said task in said medical records database.
